(19) United States
(12) Patent Application Publication
(10) Pub. No.: US 2010/0110684 A1
(43) Pub. Date: May 6, 2010

(54) LIGHT EMITTING DIODE LUMINAIRES AND APPLICATIONS THEREOF

(75) Inventors: Yaser Abdelsamed, Granville, OH (US); Jeffrey D. McClow, Newark, OH (US); Januk Aggarwal, New Albany, OH (US); Luke J. Siefker, Blacklick, OH (US); Jonathan Meyer, Westerville, OH (US); Robert W. Scites, Columbus, OH (US); Kellis Coffman, Heath, OH (US); Chris Rice, New Philadelphia, OH (US); Yelena N. Kaplan, Columbus, OH (US); Michael M. Minarczyk, Granville, OH (US)

Correspondence Address: JOHN S. PRATT, ESQ;KILPATRICK STOCKTON, LLP, 1100 PEACHTREE STREET, SUITE 2800, ATLANTA, GA, 30309, US

(73) Assignee: ABL IP HOLDING LLC, Conyers, GA (US)

(21) Appl. No.: 12/607,528

(22) Filed: Oct. 28, 2009

Related U.S. Application Data
(60) Provisional application No. 61/197,486, filed on Oct. 28, 2008.
(60) Provisional application No. 61/118,045, filed on Nov. 26, 2008.
(60) Provisional application No. 61/119,802, filed on Dec. 4, 2008.

(51) Int. Cl. F21S 4/00; B23P 11/00

(52) U.S. Cl. 362/249.02; 29/428

(57) ABSTRACT

LED assemblies and luminaires comprising the same are described herein. In some embodiments, the LED assemblies and luminaires are suitable for use in a wide variety of applications including outdoor lighting applications such as roadway and sidewalk lighting, parking lot lighting and residential area lighting.

### RELATED APPLICATION DATA

The present application hereby claims priority pursuant to 35 U.S.C. § 119(e) to U.S. Provisional Patent Application Ser. No. 61/197,486 filed Oct. 28, 2008, U.S. Provisional Patent Application Ser. No. 61/118,045 filed Nov. 26, 2008 and U.S. Provisional Patent Application Ser. No. 61/119,802 filed Dec. 4, 2008, each which is hereby incorporated by reference in its entirety.

### FIELD OF THE INVENTION

The present invention relates to luminaires and, in particular, to luminaires comprising light emitting diodes (LEDs).

### BACKGROUND OF THE INVENTION

Luminaires for providing general illumination to an area are well known and often used in outdoor lighting applications including roadway and sidewalk lighting, parking lot lighting, and residential area lighting. In order to increase luminaire efficiency, LEDs have been incorporated into luminaire design as a light source. LEDs offer several advantages including high lighting efficiency, long lifetimes that can exceed 50,000 hours of operation, resistance to physical or mechanical shock and rapid lighting response time.

Conversely, LEDs additionally exhibit several disadvantages which challenge their use in luminaire constructions, including luminaires used for general outdoor illumination. The performance of a LED, for example, is largely dependent on the temperature of the operating environment. Operating LEDs in high ambient temperatures can lead to overheating and device failure. Moreover, LEDs generally are offered in relatively low lumen packages, necessitating large numbers to create the required lighting levels. As a result, it can be difficult to achieve sufficient illumination over a wide area with LED sources while maintaining uniformity and avoiding direct glare.

Furthermore, LEDs are sensitive to electrical fluctuations and require the proper current. Voltage surges and spikes can significantly damage LEDs resulting in device failure. LED packages used in outdoor applications additionally require complex housing structures to isolate the LEDs and associated electrical equipment from various environmental elements.

### SUMMARY

The present invention, in some embodiments, provides LED assemblies and luminaires comprising the same, which can eliminate or mitigate one or more disadvantages associated with LED light sources, including overheating, electrical fluctuations and/or complex assembly structures and requirements.

In one embodiment, a LED assembly of the present invention comprises at least one LED coupled to a printed circuit board, a heat sink for the at least one LED, an optic disposed over the at least one LED and one or more clips binding the optic, LED/printed circuit board and heat sink. In some embodiments, a LED assembly comprises a plurality of LEDs coupled to a printed circuit board. The optic of the LED assembly, in some embodiments, is disposed over the plurality of LEDs.

Moreover, in some embodiments, a luminaire of the present invention comprises at least one LED assembly as a light source and a plurality of fins. A LED assembly, in some embodiments, comprises at least one LED coupled to a printed circuit board, a heat sink for the at least one LED, an optic disposed over the at least one LED and one or more clips binding the optic, LED/printed circuit board and heat sink. Moreover, in some embodiments, one or more fins of the luminaire has a structure to facilitate passage of convective air currents through the luminaire resulting in the cooling of the LEDs disposed therein. The design of the fins, in some embodiments, accelerates convective air currents over the surface area of the fins enhancing the cooling of LEDs of the luminaire.

In another aspect, the present invention provides a luminaire comprising at least one LED assembly as a light source and an electrical structure including an electrical protection device operable to protect the at least one LED assembly from voltage surges and/or other transient voltage spikes. In some embodiments, an electrical protection device comprises a metal oxide varistor and filter stage.

In a further aspect, the present invention provides methods of producing a LED assembly. In one embodiment, a method of producing a LED assembly comprises providing at least one LED coupled to a printed circuit board, disposing the printed circuit board on a heat sink surface, disposing an optic over the at least one LED and binding the optic to the heat sink with at least one clip or fastener.

LED assemblies and luminaires described herein, in some embodiments, are suitable for use in a wide variety of applications including outdoor lighting applications such as roadway and sidewalk lighting, parking lot lighting and residential area lighting.

These and other embodiments are described in greater detail in the detailed description which follows.

### BRIEF DESCRIPTION OF THE DRAWINGS

FIG. 1 is a cross-sectional view of a LED assembly according to one embodiment of the present invention.

FIG. 2 is a perspective view of a luminaire according to one embodiment of the present invention.

FIG. 3 is a top plan view of a luminaire according to one embodiment of the present invention.

FIG. 4 is a bottom plan view of a luminaire according to one embodiment of the present invention

FIG. 5 is a generalized block diagram of an electrical protection device according to one embodiment of the present invention.

FIG. 6 is a circuit diagram for an electrical protection device according to one embodiment of the present invention.

FIG. 7 illustrates several views of an optic of an LED assembly according to one embodiment of the present invention.

FIG. 8 illustrates several views of an optic of an LED assembly according to one embodiment of the present invention.

FIG. 9 is a polar plot of a luminaire according to one embodiment of the present invention.

### DETAILED DESCRIPTION

The present invention can be understood more readily by reference to the following detailed description and drawings and their previous and following descriptions. Elements, apparatus and methods of the present invention, however, are not limited to the specific embodiments presented in the detailed description and drawings. It should be recognized that these embodiments are merely illustrative of the principles of the present invention. Numerous modifications and adaptations will be readily apparent to those of skill in the art without departing from the spirit and scope of the invention.

The present invention, in some embodiments, provides LED assemblies and luminaires comprising the same, which can eliminate or mitigate one or more disadvantages associated with LED light sources, including overheating, electrical fluctuations and/or complex assembly structures and requirements.

In one embodiment, a LED assembly of the present invention comprises at least one LED coupled to a printed circuit board, a heat sink for the at least one LED, an optic disposed over the at least one LED and one or more clips binding the optic, LED/printed circuit board and heat sink. In some embodiments, a LED assembly comprises a plurality of LEDs coupled to a printed circuit board. The optic of the LED assembly, in some embodiments, is disposed over the plurality of LEDs.

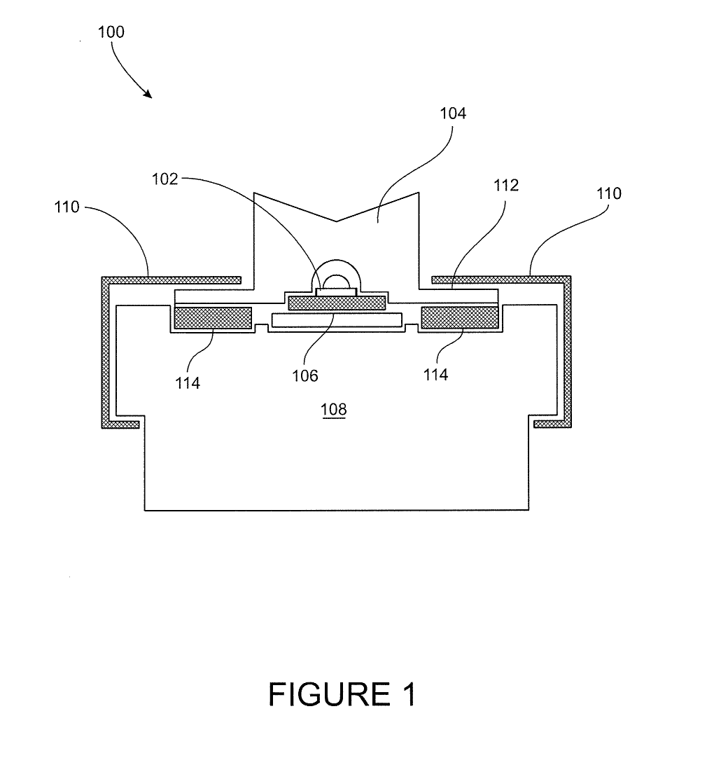

FIG. 1 illustrates a cross-sectional view of a LED assembly according to one embodiment of the present invention. The LED assembly (100) of FIG. 1 comprises a LED/printed circuit board assembly (102) and an optic (104) disposed over the LED/printed circuit board assembly (102). In some embodiments, the LED/printed circuit board assembly (102) comprises a single LED. In other embodiments, the LED/printed circuit board assembly comprises a plurality of LEDs under the optic.

In the embodiment illustrated in FIG. 1, the LED/printed circuit board assembly (102) is disposed on a thermally conductive material (106) that is in contact with a heat sink (108). The thermal conductive material (106), in some embodiments, can also be a dielectric if dielectric separation of the LED/printed circuit board assembly (102) and heat sink (108) is desirable or required. In other embodiments, the LED/printed circuit board assembly (102) is disposed on a surface of the heat sink (108).

One or more clips (110) are positioned around the LED assembly (100) binding the optic (104), LED/printed circuit board assembly (102) and heat sink (108). As illustrated in FIG. 1, the optic (104) can comprise flanges (112) or other structures for receiving the clips (110). When secured by one or more clips (110), the optic (104) can seal and protect the LED/printed circuit board assembly (102) from various degradative environmental factors. In some embodiments, one or more gaskets (114) can be disposed between the optic (104) and the heat sink (108) to further seal the LED/printed circuit board assembly (102) and provide further protection from various environmental factors.

In some embodiments a single clip can extend between or along a plurality of LED assemblies to secure a plurality of optics to the corresponding heat sinks.

The use of one or more clips, in some embodiments, can reduce the complexity of coupling the optic of a LED assembly to the heat sink and sealing the LED/printed circuit board assembly. Prior methods of coupling an optic required use of a sealant to seal the optic to the assembly for protection of the LED/printed circuit board. Use of a sealant often required a curing step that increased time and cost of manufacture. In some embodiments, one or more clips obviates the requirement of a sealant, adhesive or other chemical agent for bonding, sealing or otherwise securing the optic to the heat sink.

In some embodiments, additional mechanical fasteners including, but not limited to, screws, pins, etc. may optionally be used to further reinforce the LED assembly. Such additional fasteners may be particularly useful in applications where the LED assembly is subject to vibration or additional robustness of the LED assembly is required.

Optics suitable for use in LED assemblies described herein can comprise any optic not inconsistent with the objectives of the present invention. In some embodiments, the optic is used to alter or control the light projection of the LED(s). In some embodiments, for example, the optic is adapted to broaden the light projection of the LED(s). In other embodiments, the optic is adapted to narrow the light projection of the LED(s). Moreover, in some embodiments, the optic can assist in providing a symmetrical light distribution from the LED assembly. In other embodiments, the optic can assist in providing an asymmetrical light distribution from the LED assembly.

In some embodiments, the optic comprises two or more surfaces providing for the total internal reflection of at least a portion of the light emitted from the at least one LED into two or more substantially collimated beams, the beams directionally divergent from one another. The two or more surfaces, in some embodiments, are parabolic surfaces. Additionally, in some embodiments, other portions of the optic can comprise refractive surfaces for bending light emitted from the at least one LED into a suitable or desired pattern on the application space.

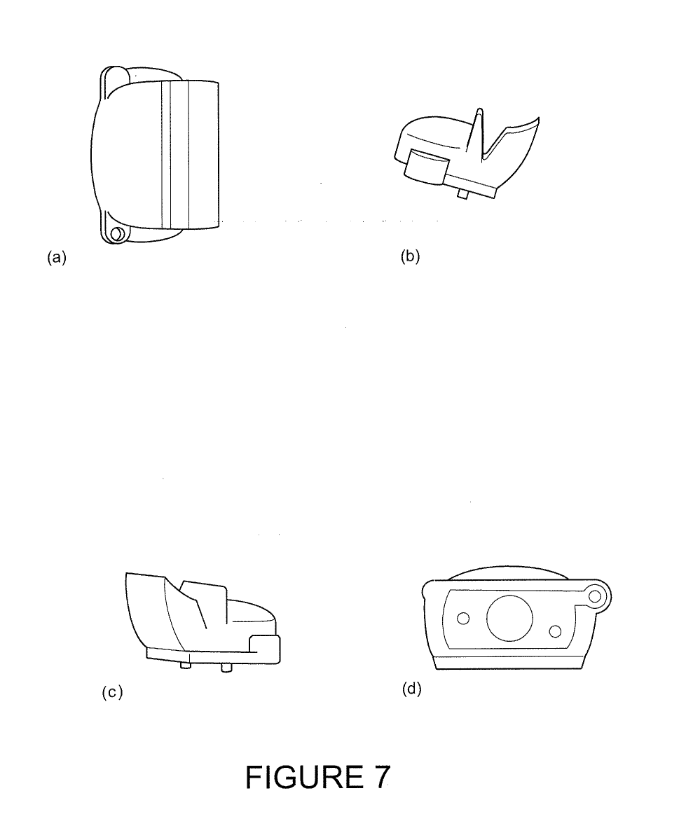

FIG. 7 illustrates several views of an optic according to one embodiment of the present invention. FIG. 7(a) provides a top view and FIG. 7(d) provides a bottom view of an optic according to one embodiment of the present invention. FIGS. 7(b) and 7(c) provide perspective views of the optic according to one embodiment of the present invention.

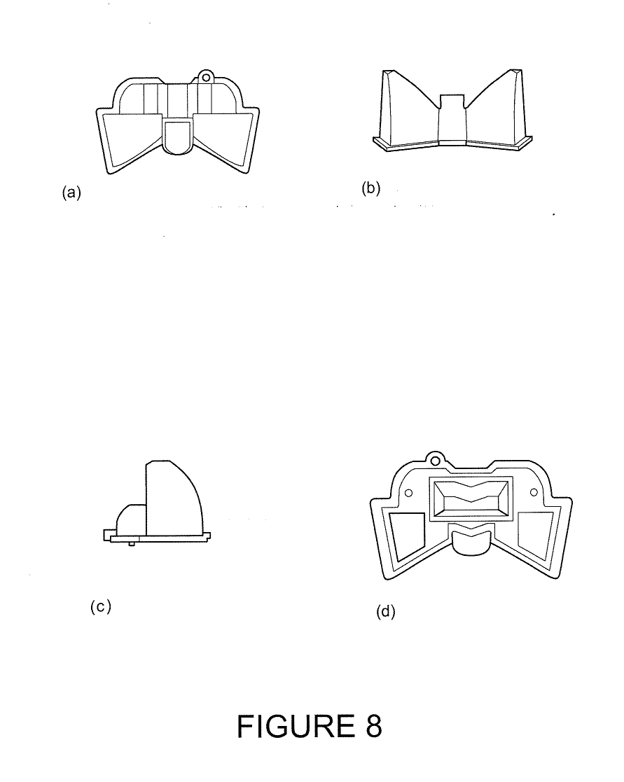

Additionally, FIG. 8 illustrates several views of an optic according to one embodiment of the present invention. FIG. 8(a) provides a top view and FIG. 8(d) provides a bottom view of an optic according to one embodiment of the present invention. FIGS. 8(b) and 8(c) provide perspective views of the optic according to one embodiment of the present invention.

In some embodiments, an optic described herein comprises glass, a radiation transmissive polymeric material or combinations thereof. In some embodiments, an optic can be fabricated by molding techniques. In other embodiments, an optic can be fabricated by chemically or lithographically etching a glass or polymeric substrate.

LEDs suitable for use in luminaires described herein can comprise any LED not inconsistent with the objectives of the present invention. LEDs, in some embodiments, comprise inorganic materials including, but not limited to, II/VI semiconductor materials, III/V semiconductor materials, group IV semiconductor materials or combinations thereof. In other embodiments, LEDs comprise organic materials including, but not limited to, semiconducting polymeric materials.

In some embodiments, suitable LEDs are commercially available from Cree, Inc. of Durham, N.C., Nichia Corporation of Tokyo, Japan, Sylvania Corporation of Danvers, Mass. and/or Phillips Lumileds Lighting Co. of San Jose, Calif.

Moreover, a heat sink of a LED assembly can comprise any material not inconsistent with the objectives of the present invention. In some embodiments, a heat sink comprises a metal or alloy. Suitable metals, in some embodiments, comprise aluminum, copper, gold, silver and/or other transition metals. A heat sink, in some embodiments, comprises a material having a thermal conductivity greater than about 10 W/mK.

A clip of a LED assembly can comprise any material not inconsistent with the objectives of the present invention. In some embodiments, a clip comprises a polymeric material. In other embodiments, a clip comprises a metal. In some embodiments, clips comprise arms that are biased (such as spring biased) towards one another. In this way, the clips can exert a clamping force or exert pressure on the optic and heat sink to bind components of the LED assembly as described herein and to enhance the sealing and/or thermal performance of the LED assembly.

In another aspect, the present invention provides a luminaire comprising at least one LED assembly as a light source and a plurality of fins The fins of the luminaire, in some embodiments, have a structure or design to facilitate the passage of convective air currents through the luminaire resulting in the cooling of the LEDs disposed therein. In some embodiments, the structure or design of the fins accelerate convective air currents passing over the surface area of the fins, thereby enhancing cooling of one or more LEDs of the luminaire.

One or more fins, in some embodiments, comprise a tapered structure wherein one end of the fm is thicker than the opposing end of the fin. A fin, in some embodiments, is thicker in a region corresponding to a convective air inlet and thinner in a region corresponding to a convective air outlet. In some embodiments, the ratio of the thicker end of a fin to the thinner end of a fin ranges from about 2 to about 10. In other embodiments, the ratio of the thicker end of a fin to the thinner end of a fin ranges from about 3 to about 7 or from about 4 to about 6. The tapered construction of the fins, in some embodiments, allows for convective air currents to accelerate as the currents pass over the fined surface area, thereby enhancing or improving LED cooling of the luminaire.

In some embodiments, the plurality of fins are provided as an array. Moreover, in some embodiments, the plurality of fins are integral or continuous with the housing of the luminaire. In some embodiments wherein the plurality of fins are integral or continuous with the housing, the fins are fabricated with or as part of the housing. In one embodiment, for example, the plurality of fins can be co-molded with the housing resulting in a continuous structure.

In other embodiments, the plurality of fins can be provided as a component independent from the housing. A fin component independent from the housing can be coupled to the housing by any desired means.

The plurality of fins can be constructed of any desired material not inconsistent with the objectives of the present invention. In some embodiments, the plurality of fins are constructed from a polymeric material. Polymeric materials, in some embodiments, comprise one or more thermoplastics or one or more thermosets. In some embodiments, a polymeric material may have one or more reinforcing agents such as glass fibers. In another embodiment, the plurality of fins are constructed of a metal. Suitable metals can comprise aluminum, stainless steel, copper or various alloys. In some embodiments, the plurality of fins are constructed of one or more ceramics or other material having an acceptable thermal conductivity.

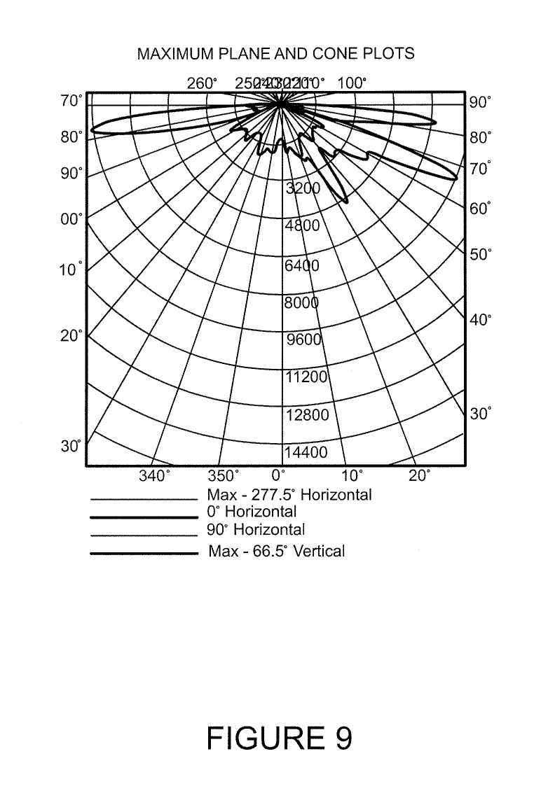

In addition to the plurality of fins, luminaires described herein can have any desired number of LEDs assemblies. In some embodiments, a luminaire comprises one or more arrays of LED assemblies. In one embodiment, for example, a luminaire comprises two or more arrays of LED assemblies. In some embodiments, luminaires described herein comprising LED assemblies can meet the lighting performance of existing high intensity discharge luminaires per IES RP-8 design criteria without increasing the required number of luminaires or increasing the energy consumed by the luminaires. FIG. 9 illustrates a polar plot of a luminaire according to one embodiment of the present invention.

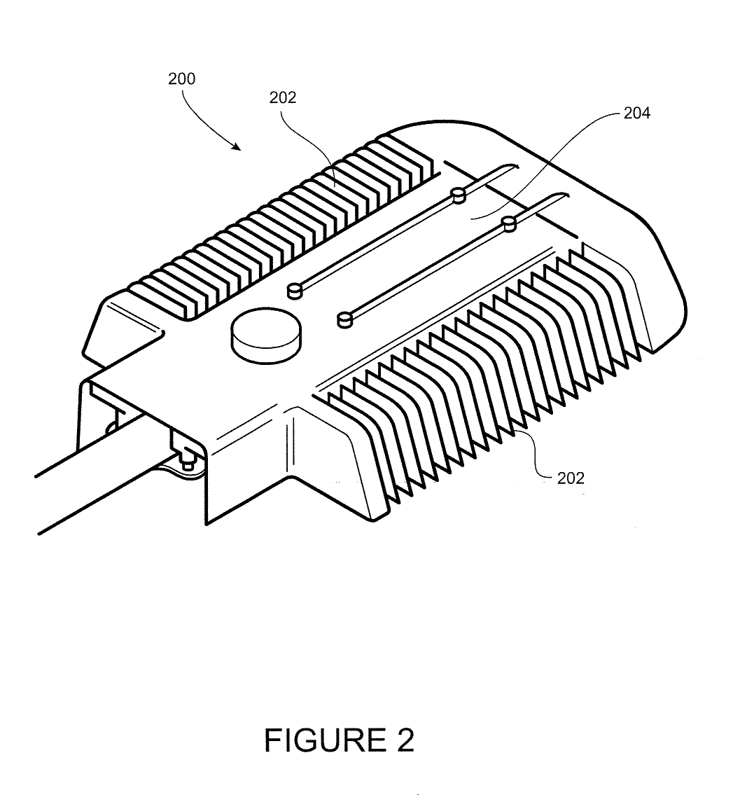

FIG. 2 is a perspective view of a luminaire according to one embodiment of the present invention. As illustrated in FIG. 2, the luminaire (200) comprises a plurality of tapered fins (202). The tapered fins (202) are provided as arrays integral with the housing (204) of the luminaire (200).

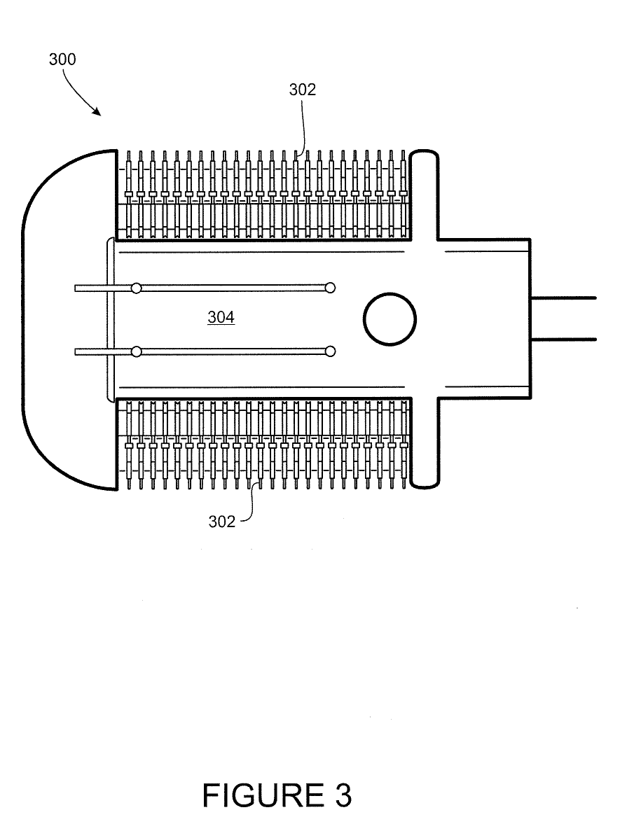

FIG. 3 is a top plan view of luminaire according to one embodiment of the present invention. As illustrated in FIG. 3, the luminaire (300) comprises a plurality of tapered fins (302). The tapered fins (302) are provided as arrays integral with the housing (304) of the luminaire (300).

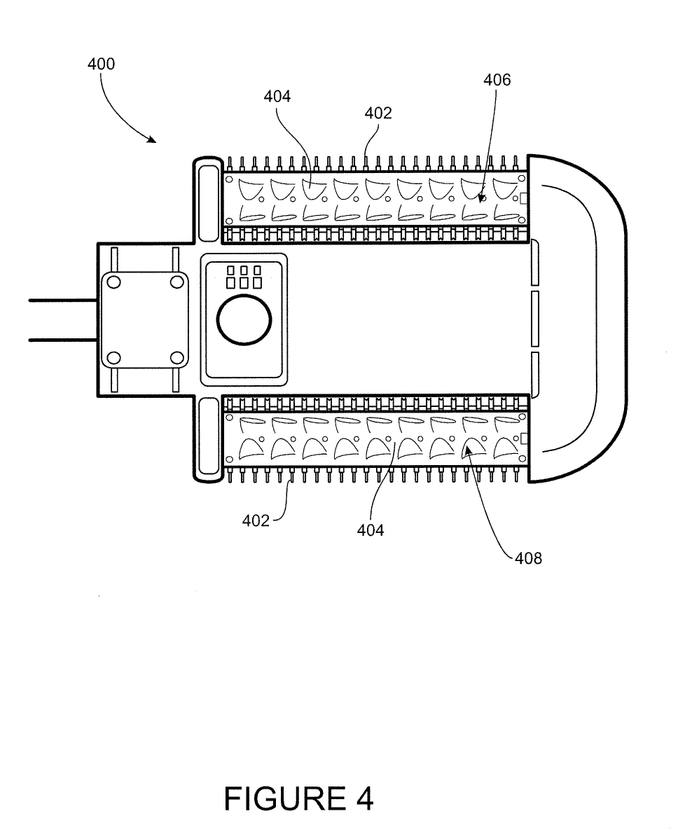

FIG. 4 is a bottom plan view of a luminaire according to one embodiment of the present invention. As illustrated in FIG. 4, the luminaire (400) comprises a plurality of tapered fins (402). The plurality of tapered fins (402) are provided as arrays. Moreover, the plurality of tapered fins (402) are proximate a plurality of LEDs (404) arranged into two column arrays (406, 408).

In some embodiments, luminaires described herein further comprise an electrical structure comprising an electrical protection device operable to protect one or more LED assemblies from voltage surges and/or other transient voltage spikes. In some embodiments, the electrical protection device comprises a metal oxide varistor (MOV) and a filter stage.

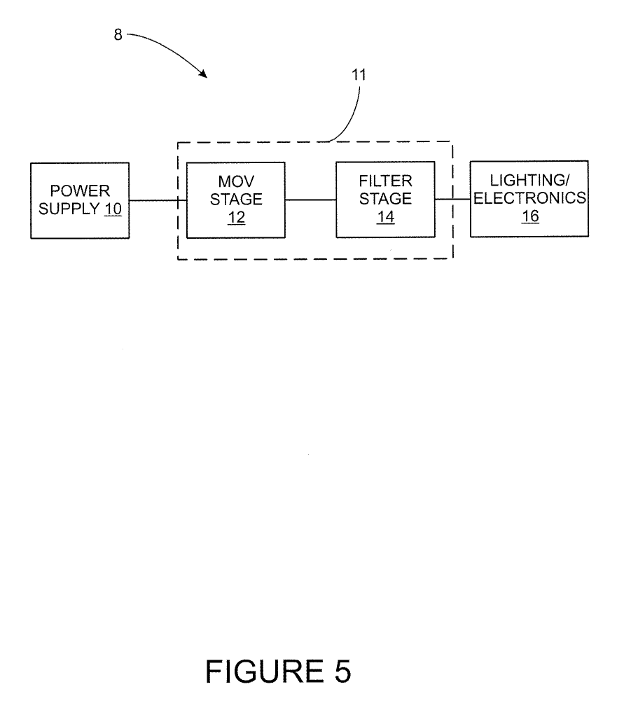

FIG. 5 is a generalized block diagram showing a circuit (8) configured in accordance with one embodiment of an electrical protection device of the present invention. Circuit (8) comprises an electrical protection device (11) between a power supply/source (10) and LED assemblies and related electronics (16). In the embodiment of the FIG. 5, the electrical protection device (11) comprises a MOV stage (12) and a filter stage (14). In contrast to electrical protection configurations that use a single component based entirely on MOVs, electrical protection device (11) includes both MOVs and provides filtering. This may advantageously protect against let-through transients and allow the use of more sensitive electronics and lighting components than would be possible or advisable if a single device surge protection component were to be used alone.

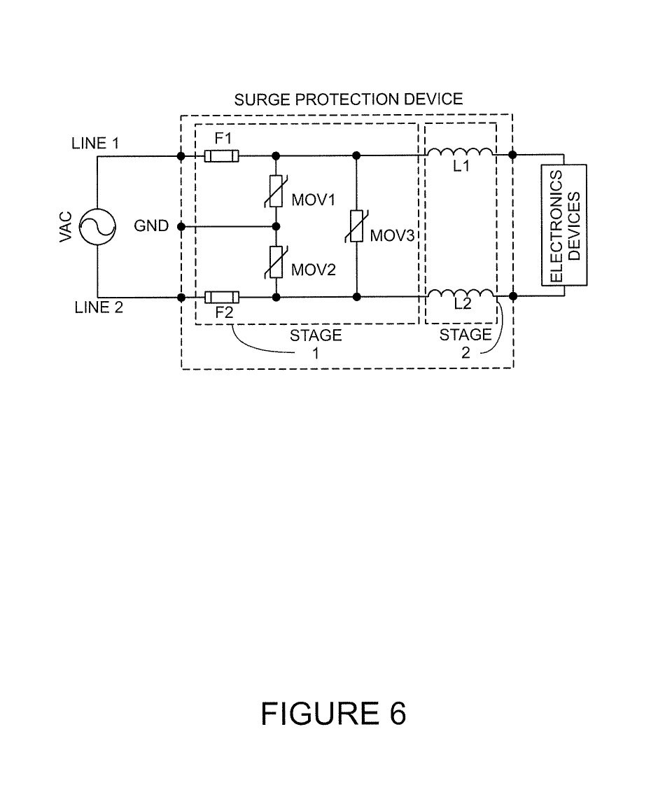

FIG. 6 is a circuit diagram illustrating an exemplary circuit for an electrical protection device according to one embodiment of the present invention. In the embodiment illustrated in FIG. 6, the power supply (10) comprises an AC voltage source VAC with LINE 1 and LINE 2 terminals. A ground terminal GND is also available. The electrical protection device is represented by the larger box outlining two stages, Stage 1 and Stage 2. The electrical protection device is further connected to a load that can comprise one or more LED assemblies with related electronics, represented in FIG. 6 by “Electronics Devices.”

The MOV stage (Stage 1) includes a line fuse (F1, F2) on each of the two lines LINE 1 and LINE 2. For example, fuses F1 and F2 may comprise thermal or current-type fuses that are triggered by excessive current or temperature. In the event that the electrical protection device fails, one or both of these fuses will open (i.e. “blow”) and disable the electronics and thereby prevent the electronics from experiencing an unprotected state or a high internal temperature within the electrical protection device. After the fuses, MOV devices (MOV1, MOV2, MOV3) are arranged to protect against common mode (MOV1, MOV2) and differential mode (MOV3) transients.

Stage 2 represents the filter stage. The filter stage is effectively a filter circuit that blocks high-frequency let-through transients but allows low frequency voltage (e.g. 60 Hz line voltage) to pass to the electronics. Thus, in some implementations, the filter stage comprises a low-pass filter. In this example, the impedance circuit comprises two inductors (L1, L2), with one inductor on each power line and creating a balanced line that allows the device to be used in various voltage configurations. For example, the device could be used in a 208 V configuration with a hot and neutral line or a 240 V configuration with both lines hot.

By combining the filter stage with the MOV stage, an electrical protection device, in some embodiments, can provide sufficient protection for LED assemblies and/or other sensitive electronics of luminaires described herein. In some embodiments, the electrical protection device is integral with other electronics of the luminaire. In other embodiments, the electrical protection device can be configured as an add-on electrical protection module and included as a system component.

In a further aspect, the present invention provides methods of producing a LED assembly. In one embodiment, a method of producing a LED assembly comprises providing at least one LED coupled to a printed circuit board, disposing the printed circuit board on a heat sink surface, disposing an optic over the at least one LED and binding the optic to the heat sink with at least one clip or fastener. In some embodiments, a method further comprises disposing one or more gaskets between the optic and the heat sink. Moreover, in some embodiments, a thermally conductive material is disposed between the printed circuit board and the heat sink. The thermally conductive material, in some embodiments, is additionally a dielectric material.

Various embodiments of the invention have been described in fulfillment of the various objectives of the invention. It should be recognized that these embodiments are merely illustrative of the principles of the present invention. Numerous modifications and adaptations thereof will be readily apparent to those skilled in the art without departing from the spirit and scope of the invention.

That which is claimed is:

1. A light emitting diode (LED) assembly comprising:
at least one LED coupled to a printed circuit board;
an optic disposed over the LED;
a heat sink; and
one or more clips binding the optic, the LED/printed circuit board and the heat sink.

2. The LED assembly of claim 1, wherein the LED/printed circuit board contacts a surface of the heat sink.

3. The LED assembly of claim 1 further comprising a thermally conductive material disposed between the LED/printed circuit board and the heat sink.

4. The LED assembly of claim 3, wherein the thermally conductive material is a dielectric material.

5. The LED assembly of claim 1 further comprising one or more gaskets disposed between the optic and the heat sink.

6. The LED assembly of claim 1, wherein the optic comprises one or more flanges for engaging the one or more clips.

7. The LED assembly of claim 1, wherein the one or more clips comprise arms biased toward one another.

8. A luminaire comprising:
at least one LED assembly; and
a plurality of tapered fins.

9. The luminaire of claim 8, wherein the at least one LED assembly comprises a LED coupled to a printed circuit board, an optic disposed over the LED, a heat sink and one or more clips binding the optic, the LED/printed circuit board and the heat sink.

10. The luminaire of claim 8, wherein the plurality of fins are present as one or more arrays of fins.

11. The luminaire of claim 8, wherein at least one of the plurality of fins is thicker at a convective air inlet than at a convective air outlet.

12. The luminaire of claim 9 comprising a plurality of LED assemblies in an array format.

13. The luminaire of claim 8 further comprising an electrical structure comprising an electrical protection device.

14. The luminaire of claim 13, wherein the electrical protection device comprises a metal oxide varistor and a filter stage.

15. The luminaire of claim 14, wherein the filter stage comprises a low-pass filter.

16. The luminaire of claim 14, wherein the metal oxide varistor comprises one or more line fuses.

17. A method of producing a LED assembly comprising:
providing at least one LED coupled to a printed circuit board;
disposing the printed circuit board on a heat sink surface;
disposing an optic over the at least one LED; and
binding the optic to the heat sink with at least one clip.

18. The method of claim 17 further comprising disposing at least one gasket between the optic and the heat sink.

19. The method of claim 17 further comprising disposing a thermally conductive material between the printed circuit board and the heat sink surface.

20. The methods of claim 19, wherein the thermally conductive material is a dielectric material.
